(19) United States
(12) Patent Application Publication
(10) Pub. No.: US 2002/0177346 A1
(43) Pub. Date: Nov. 28, 2002

(54) Connection system for flexible flat strip cables

(76) Inventors: Hans-Otto Geltsch, Berg-Sindlbach (DE); Michael Hopf, Numberg (DE); Robert Janitschke, Numberg (DE)

Correspondence Address: PERMAN & GREEN, 425 POST ROAD, FAIRFIELD, CT, 06824, US

(21) Appl. No.: 10/116,300

(22) Filed: Apr. 4, 2002

(30) Foreign Application Priority Data
Apr. 4, 2001 (DE) 101 16 454

(51) Int. Cl. H01R 13/62

(52) U.S. Cl. 439/329

(57) ABSTRACT

The present invention relates to a connection system for flexible flat strip cables (1a,1b) comprising conductors arranged parallel to one another, which are stripped of insulation in the area of the connection which is to be made and which are provided with means of positive fixing of the flexible flat strip cables to be connected in a connection housing (2), which has two housing parts (2a,2b) able to be joined together and a slide (3) for the pressing together in the areas which have been stripped of insulation, of the flexible flat strip cables (1a,1b), which are to be connected.

### BACKGROUND OF THE INVENTION

1. Field of the Invention

The present invention relates to a connection system for flexible flat strip cables comprising parallel strip conductors arranged at a distance from one another. These are stripped of insulation in the area of the connection which is to be made and are pressed to one another in that area.

Such flat strip cables are used in vehicles for, for example, loop circuits of multiplex systems for the distribution of current and control signals. Branch conductors lead from these loop circuits to consuming points, sensors or the like. According to the individual equipment of a motor vehicle, different cabling layouts are required. There is therefore a great need for connection systems with which it is possible to connect branch conductors, simply and rapidly, to principal flat strip cable loop circuits.

2. Brief Summary of the Invention

It is accordingly the purpose of the present invention to provide a connection system for flexible flat strip cables, which can be used to connect several flat strip cables simply and rapidly to one another at any desired points.

This purpose is reached according to one of the claims with the characteristics of preferred embodiments of the present invention appearing in the subsidiary claims. The present invention is based on the idea of selectively stripping the insulation from flexible flat strip cables in any places from which branch conductors or the like are to be led, to press the conductor areas stripped of insulation to one another and to provide housings able to be joined together in the simplest possible manner and with which the flexible flat strip cables to be connected can be exactly positioned with respect to one another and subsequently pressed to one another.

### BRIEF DESCRIPTION OF THE DRAWINGS

The invention is explained in greater detail by means of the description of preferred embodiment examples and by reference to drawings:

FIG. 1 shows in perspective a longitudinal section of the first embodiment of the present invention;

FIGS. 2a to 2e show the preparation of a connection of two flat strip cables, using the connection system according to FIG. 1

FIG. 3 shows two versions of the connection of the housing parts; and

FIG. 4 shows a second embodiment of a connection system according to the invention.

### DETAILED DESCRIPTION OF THE INVENTION

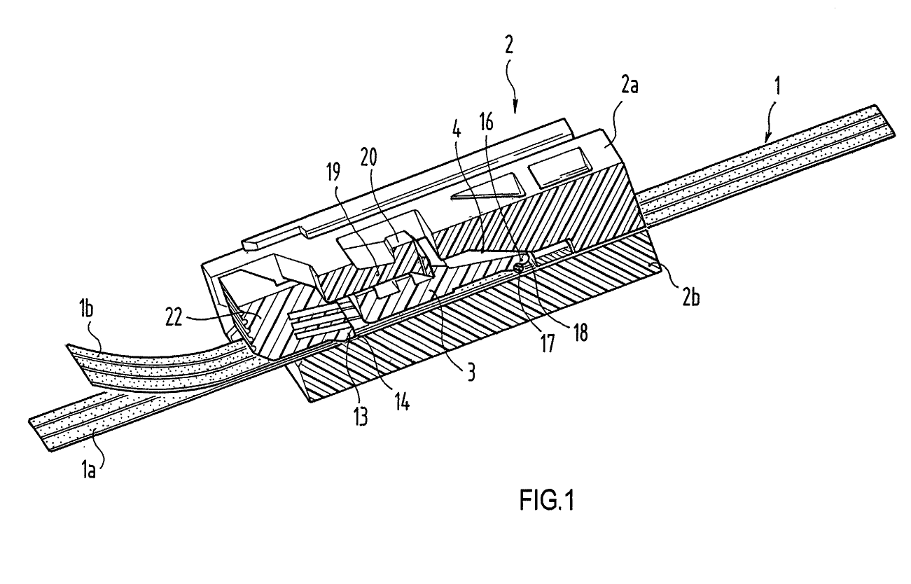

FIG. 1 shows a longitudinal section of a first embodiment along the central axis of the flat strip cable 1. This consists of conductors arranged parallel to one another, which are connected to a flexible plastic support and insulated thereby. The connection housing 2 consists of an upper housing part 2a, a lower housing part 2b and a slide 3. As is shown in FIG. 1, the slide 3 can be slid between a front lock-in position and an end lock-in position, in which the areas of the flexible flat strip cable 1a,1b, which have been stripped of insulation are to be pressed to one another. The upper housing part 2a has a ramp 4, along which the wedge-shaped slide 3, when being slid into its end lock-in position, is pressed increasingly firmly against the flexible flat strip cables lying opposite one another. The locking arm 19 has, in the upper housing part 2a, for locking the wedge slide 3 into the front- or back lock-in position, a bracket 20, into which a loosening tool or a fingernail can be inserted in order to take off the lock and release the slide 3. The slide 3 also has a catch stop 13, elastically suspended from the spring arms, which snaps into the corresponding recesses 14 of the branch cable 1b which is to be connected with the principal cable 1a, whereby the branch cable 1b is, during the travel of the slide 3, pulled into its end lock-in position and an exactly defined positioning takes place of the areas of the principal cable 1a and the branch cable 1b which have been stripped of insulation. A pressure rib 18 is formed on the front face of the slide 3, whereby the pressure is locally distributed over a small section surface. This pressure rib 18 may have introduced into it an insert of silicone or rubber or the like, in order to increase adhesion there between the slide and the branch conductor and in order to achieve an even force distribution over the entire flexible conductor under a permanent load.

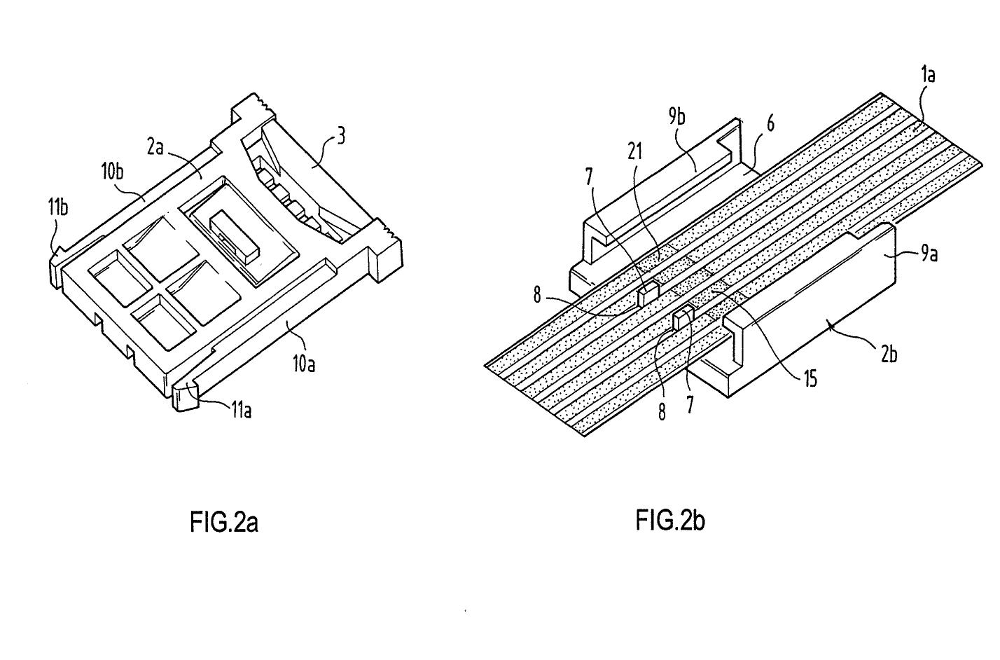

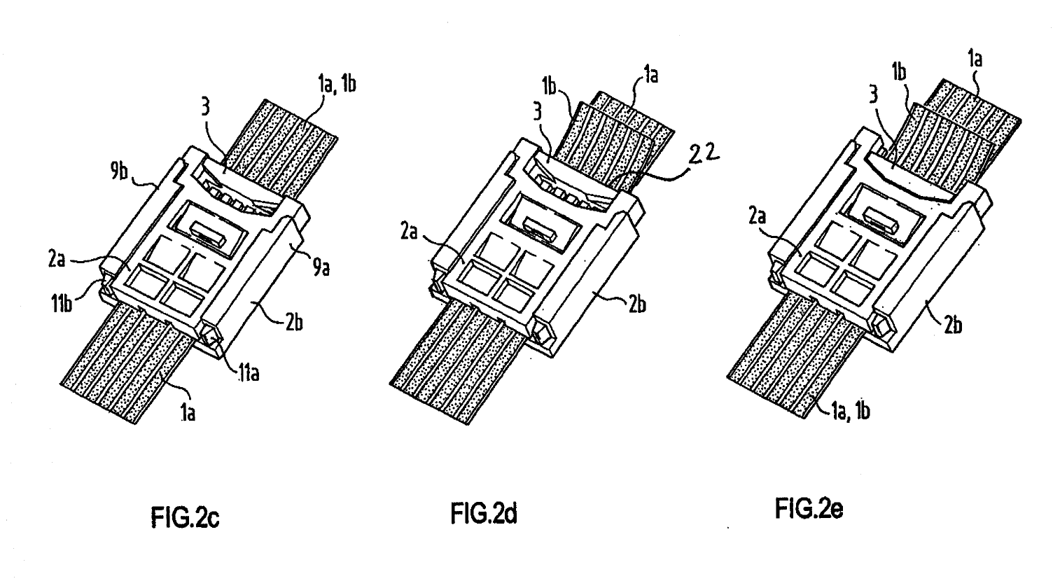

FIGS. 2a to 2e show the process of assembly of the first embodiment example of the connection system according to FIG. 1. FIG. 2a shows the upper part 2a of the housing 2 with the pre-assembled slide 3 in the front lock-in position. The upper housing part 2a has, arranged on flexible arms on its sides, outward-pointing snap-in latches 11a and 11b.

FIG. 2b shows the lower housing part 2b with a floor area 6 for receiving the flexible flat strip cable 1a. This has recesses 8 into which snap the locking stops 7 which are provided in the floor area 6, whereby a precise positioning of the flat strip cable 1a on the floor area 6 of the lower housing part 2b of the housing 2 takes place. FIG. 2b moreover shows the areas 21 which have been stripped of insulation, opposite which should lie the correspondingly stripped areas of the branch flat strip cable 1b.

FIG. 2c shows the next step of the assembly, in which both the housing parts 2a and 2b are joined to the pre-assembled slide 3, where the two housing parts snap to the end of the guide grooves 9a or 9b by means of the snap-in latches 11a, 11b.

FIG. 2d shows as the next step the insertion of the branch flat strip cable 1b into the assembled housing from the side on which the actuating surface 22 of the wedge-shaped slide 3 protrudes from the housing in the front lock-in position. The branch flat strip cable 1b is inserted into the housing 2, until the recesses 14 which are provided on the flat strip cable 1b, reach the level of the snap-in catch stops 13 which snap into the said recesses and lock the branch flat strip cable 1b opposite the slide 3.

Lastly, FIG. 2e shows the wedge-shaped slide 3 in the end lock-in position in which the connection between the two flat strip cables 1a,1b is made. During the travel of the slide 3 into the end lock-in position, the slide pulls the branch conductor by means of locking of the catch stop 13 into the recess 14, where, by means of the wedge 4, the pressure with which the flat strip cables 1a,1b are pressed to one another gradually rises. Through the friction between any areas of the two flat strip cables 1a,1b, from which insulation has been stripped, the said contact areas are simultaneously cleaned, thereby improving electrical contact.

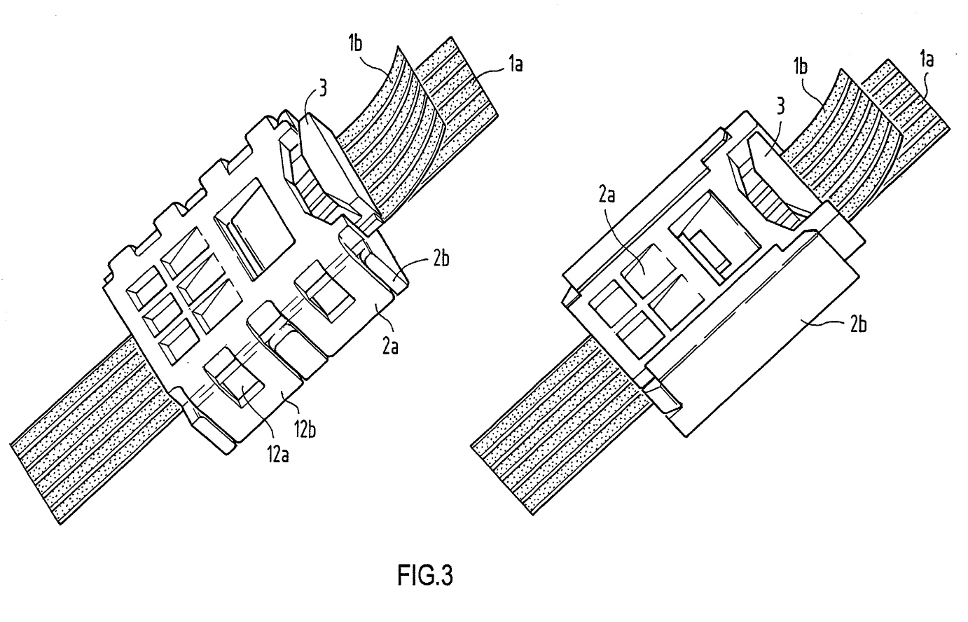

FIG. 3 shows two construction-related possibilities of fastening the two housing parts 2a, 2b to one another. On the left is shown interconnection by means of insertion vertically to the cable axis. The housing parts 2a,2b are locked together by means of locking elements 12a,12b. The version illustrated on the right side of FIG. 3 corresponds, on the other hand, to the embodiment example shown in FIG. 1, where the housing parts 2a,2b are inserted into one another in the direction of the cable axis and then locked, as has already been explained earlier in greater detail.

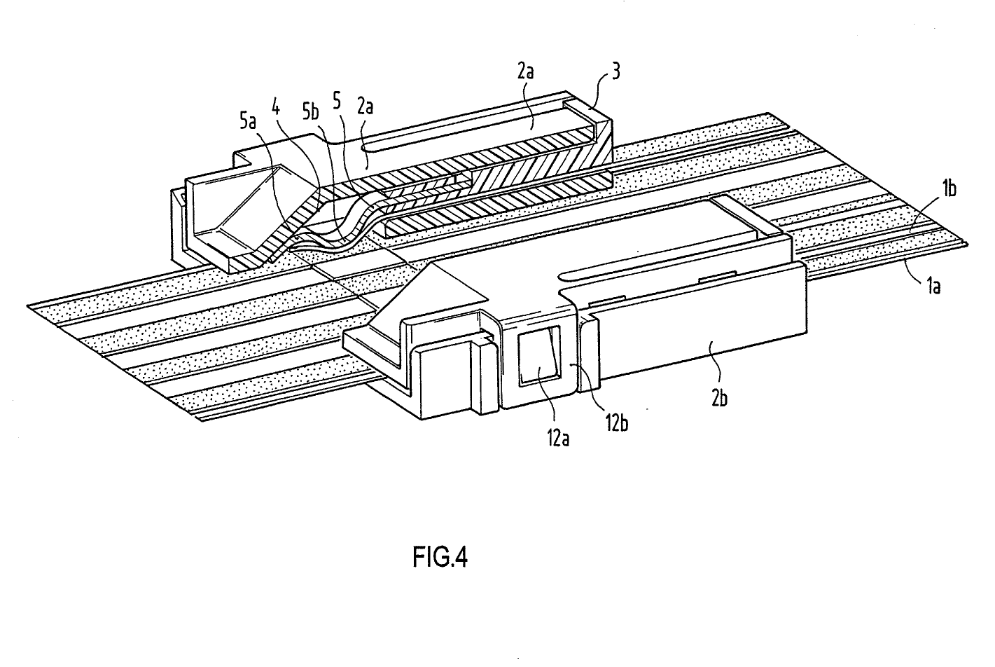

FIG. 4 shows a second embodiment of a connection system according to the invention, where the slide 3 has a flexible tongue 5 on its front face. The said flexible tongue is substantively bent into the shape of an S, where the convexity 5a on the front face slides along the ramp with its back in the course of the travel of the wedge-shaped slide 3 into the end lock-in position. This presses the flexible tongue 5 downwards, so that the second convexity 5b in the areas of the two flat strip cables 1a,1b from which insulation has been stripped and which are to be connected with one another, is pressed against them.

The fastening together of the housing parts 2a,2b also takes place via the locking elements 12a, 12b and via the insertion of the housing parts 2a, 2b into one another vertically to the flat strip cable axis.

The preceding description of two embodiment examples of the present invention has the object of illustration only and is not be to regarded as being in any way limiting.

What is claimed is:

1. A connection system for flexible flat strip cables comprising conductors arranged parallel to one another, from which insulation has been stripped in the area of the connection which is to be made and which have available a means for the positive fixing of the flexible flat strip cables to be connected in a connection housing, which has two housing parts able to be joined together and a slide for pressing together the flexible flat strip cables to be connected in the said areas which have been stripped of insulation.

2. A connection system according to claim 1, characterised by the fact that the slide is a wedge-shaped slide which is able to travel between a front lock-in position and a locking position in the direction of the cable axis.

3. A connection system according to claim 1, characterised by the fact that the slide is a flexible slide, on whose front face is arranged a ramp in a housing part, on which the flexible tongue, which is able to be pressed on the flat strip cables which are to be connected is arranged, the slide being able to travel in the direction of the cable axis between a front lock-in position and a locking position.

4. A connection system according to claim 1, characterised by the fact that a lower housing part has a floor area to receive a principal flexible strip cable, with at least one locking stop to snap into at least one corresponding recess in the cable.

5. A connection system according to claim 4, characterised by the fact that the lower housing part has axially placed side walls, with sliding grooves for the introduction and locking of an upper housing part, arranged axially to both sides of the floor area.

6. A connection system according to claim 5, characterised by the fact that the upper housing part has, on flanks which snap into the sliding grooves of the lower housing part, outward pointing snap-in latches on locking arms running axially.

7. Connection systems according to claim 4, characterised by the fact that the upper housing part and the lower housing part can be connected transversely to the direction of the axis by means of being inserted on one another by means of locks.

8. A connection system according to claim 2, characterised by the fact that the wedge-shaped slide has catch stops arranged on flexible arms for elastic snapping into recesses, with which a branch conductor is, during the travel of the wedge-shaped slide, pulled into the locking position, until the contact areas of the flexible flat strip cable which is to be connected and from which insulation has been stripped, lie on top of one another.

9. A connection system according to claim 8, characterised by the fact that the front face of the wedge-shaped slide is pressed with gradually increasing pressure into the locking position on the flexible flat strip cable by means of the ramp arranged in the upper housing part, whereby the contact areas from which insulation has been stripped, clean one another by friction against one another.

10. A connection system according to claim 3, characterised by the fact that the elastic tongue is bent into the shape of an S, so that the first convexity on the front face slides along the ramp of the upper housing part and the second convexity is pressed against the flexible flat strip cable.

11. A connection system according to claim 2, characterised by the fact that the wedge-shaped slide has on its front face a rounded pressure rib which runs transversely to the flexible flat strip cables.

12. A connection system according to claim 11, characterised by the fact that the pressure rib has, in the area of contact with the flexible flat strip cable, an insert of silicone or the like.

13. A connection system according to claim 2, characterised by the fact that a locking arm on the upper housing part for locking the slide, has a bracket for the insertion of a loosening tool.

14. A connection system according to claim 1, characterised by the fact that the lower housing part comprises an insert of silicone or the like, which acts as a support to confer long-term stability in the area of contact to provide contact strength.
